(19) United States
(12) Patent Application Publication
(10) Pub. No.: US 2009/0315313 A1
(43) Pub. Date: Dec. 24, 2009

(54) Blank book and archiving system

(76) Inventor: Michael Kalman, Tenafly, NJ (US)

Correspondence Address: Robert G. Rosenthal, Esq., Suite 200, 5856 Faringdon Place, Raleigh, NC, 27609, US

(21) Appl. No.: 12/214,462

(22) Filed: Jun. 19, 2008

(51) Int. Cl. B42D 1/00; B42D 3/00; B42D 3/12

(52) U.S. Cl. 281/16; 281/37; 281/19.1

(57) ABSTRACT

A system for archiving books of varying types and sizes for ease of identification and retrieval comprising, in combination a book and a sleeve adapted to cooperate therewith. The book is of the type that includes a plurality of pages bound to a spine between front and back covers and wherein at least a portion of the book proximate the spine is magnetized or is magnetic. The sleeve comprises a front sleeve section and a back sleeve section and a centrally positioned spine sleeve section and wherein the spine sleeve section is connected to the front sleeve section on one side and is connected to the back sleeve section on the opposite side and further, wherein at least a portion of said sleeve is magnetized or magnetic such that when said sleeve is positioned so that the front sleeve section, back sleeve section and spine sleeve section overlie the respective front cover, back cover and spine of the book, the book and the sleeve are maintained in connected relation by magnetic forces of attraction.

### FIELD OF THE INVENTION

This invention relates generally to the field of blank books and binders and more particularly to a system for labeling and presenting a variety of blank book and binder styles on a bookshelf spine-forward in an organized and visually appealing manner.

### BACKGROUND OF THE INVENTION

Blank books and binders take many forms, but their common function is to store and hold together pages uniquely created by the individual user. For example, in a sketchbook, such a book or binder stores and holds together pages of the user's drawings; similarly, in a notebook, journal, or composition book, such a book or binder stores and holds together pages of the user's writings; similarly, in a photo album, such a book or binder stores and holds together pages of the user's pictures; similarly, in a scrapbook, such a book or binder stores and holds together pages of the user's memorabilia; similarly, in a presentation book, such a book or binder stores and holds together pages of the user's demonstration; similarly, in a portfolio, such a book or binder stores and holds together the user's artwork and other materials in an unbound format.

The above paragraph asserts that there is a multiplicity of blank book and binder modalities. However, each modality also has a subset of possible binding styles and each of these styles provides a different functionality. Thus, for example, within this paradigm a sketchbook, storing and holding together the user's artwork, may be constructed in a hardbound style, providing for maximum permanency; or may be constructed in a wire bound style (otherwise known as wire-o and twin wire binding), providing for maximum flexibility and durability; or may be constructed in a spiral coil bound style, providing for maximum flexibility at the lowest cost; or may be constructed in a disk bound style, providing for removability of pages. In turn, each of the other blank book and binder modalities has its own subset of potential binding styles.

It will be noted that a user may maintain a separate blank book or binder for a specific theme and thus may use several blank books or binders simultaneously. This holds especially true for students, who may keep a separate blank book or binder for each subject during the course of a semester. Furthermore, such blank books or binders allow for, and indeed encourage, the user to make an emotional investment in the product by committing their own creativity and memory to it. It follows, that once completed, such blank books or binders are not discarded but rather retained, and often retained permanently. Thus, over the course of a lifetime, a user may accumulate a substantial collection of such blank books or binders of varying styles, sizes and types.

Storage of these blank books and binders is both an organizational and aesthetic challenge to the user. With respect to hardbound books, if stored on a shelf or in a box face forward, there is no means to identify the contents unless the user marks the cover; alternatively, if stored on a shelf, spine forward, the collection merely presents an array of solid color of the spine of the books. Similarly, with respect to spiral coil bound or wire bound books, if stored on a shelf or a box, face forward, there is no means to identify the contents unless the user marks the cover; if stored on a shelf, spine forward, the collection presents an array of unsightly metal or plastic coils without any means to identify the contents.

In view of the foregoing, it is an object of the present invention to provide a system for archiving blank books and binders of varying size and type that is an improvement over the prior art.

Another object of the present invention is to provide a system for displaying blank books and binders in an attractive manner.

Yet another object of the present invention is to provide a system for organizing blank books and binders of varying type.

Still another object of the present invention is to provide a system for identifying the contents of a particular blank book or binder.

A still further object of the invention is to provide an archiving system which allows the user to label the contents of the blank book or binder on its spine and to provide an aesthetically pleasing manner to showcase it spine forward on a bookshelf.

### BRIEF DESCRIPTION OF THE DRAWINGS

Some of the objects of the invention having been stated, other objects will appear as the description proceeds, when taken in connection with the accompanying drawings, in which—

FIG. 1 is a perspective view of the combination of a wire bound spiral coil bound book with an attached sleeve according to the present invention.

FIG. 2 is a plan view of the combination of a wire bound or spiral coil bound book with an attached sleeve according to the present invention.

FIG. 3 is a side view of the combination of a wire bound or spiral coil bound book with an attached sleeve according to the present invention.

FIG. 4 is an exploded view of the combination of a wire bound or spiral coil bound book with an attached sleeve according to the present invention.

FIG. 5 is a broken away view of the combination of a wire bound or spiral coil bound book with an attached sleeve according to the present invention.

FIG. 6 is a cross-sectional view of the front portion of a wire bound or spiral bound book with an attached sleeve, taken along line 2-2 of FIG. 2.

FIG. 6A is detailed cross-sectional view of the portion of the invention as outlined in FIG. 6.

FIG. 7 is a perspective view of the combination of a hardbound book with an attached sleeve according to the present invention.

FIG. 8 is a plan view of the combination of a hardbound book with an attached sleeve according to the present invention.

FIG. 9 is a side view of the combination of a hardbound book with an attached sleeve according to the present invention.

FIG. 10 is an exploded view of the combination of a hardbound book with an attached sleeve according to the present invention.

FIG. 11 is a cross-sectional view of the front portion of a hardbound book with an attached sleeve, taken along line 7-7 of FIG. 7.

FIG. 12 is a perspective view partially broken away of the sleeve according to the present invention.

FIG. 13 is a plan view of the sleeve according to the present invention.

FIG. 14 is a cross sectional view taken along line 12-12 of FIG. 12 of the sleeve according to the present invention.

### DETAILED DESCRIPTION OF THE ILLUSTRATED EMBODIMENTS

While the present invention will be described more fully herein after with reference to the accompanying drawings, in which particular embodiments are shown, it is to be understood at the outset that persons skilled in the art may modify the invention herein described while stilly achieving the favorable results of this invention. Accordingly, the description which follows is to be understood as a broad teaching disclosure directed to persons of skill in the appropriate arts and not as limiting upon the present invention. Further, while the description and drawings illustrate two embodiments, namely, the spiral and hardbound blank books, it will be understood that the invention may be applied to virtually all types of books, whether blank or including printed pages.

In the drawings, wherein like characters of reference generally indicate like parts throughout, 100 indicates generally a blank book or binder or book constructed in accordance with the invention and 200 indicates generally the detachable sleeve constructed in accordance with the invention. In addition, as employed herein, for ease of description, the term “blank book” is intended to cover all types of bound books and binders, irrespective of binding style, having a hard or flexible front and/or rear covers, including but not limited to, sketchbooks, journals, notebooks, composition books, scrapbooks, photo albums, presentation books, portfolios, and the like. In addition, the term “blank book” is intended to cover refillable blank books, which consist of book covers whose inside lining has an aperture into which the replacement book is inserted; with respect to the other aspects of the invention, and its key component, the magnetic or magnetizable sleeve, this refillable blank book functions in the same manner as the other modalities.

Likewise, as employed herein, the terms “magnetic” is defined as “capable of being magnetized or attracted by a magnet” and “magnetized” is defined as “to exert an attracting influence upon” will be employed somewhat interchangeably, as will become evident as the reader proceeds. The foregoing “blank books” may be assembled by a variety of binding styles including coil binding (spiral coil binding, wire-o/twin wire binding) as well as hardbound, post bound, disc bound (such as Atoma® and Rollabind®) and cloth bound (portfolios), all of which fall within the scope of the present invention.

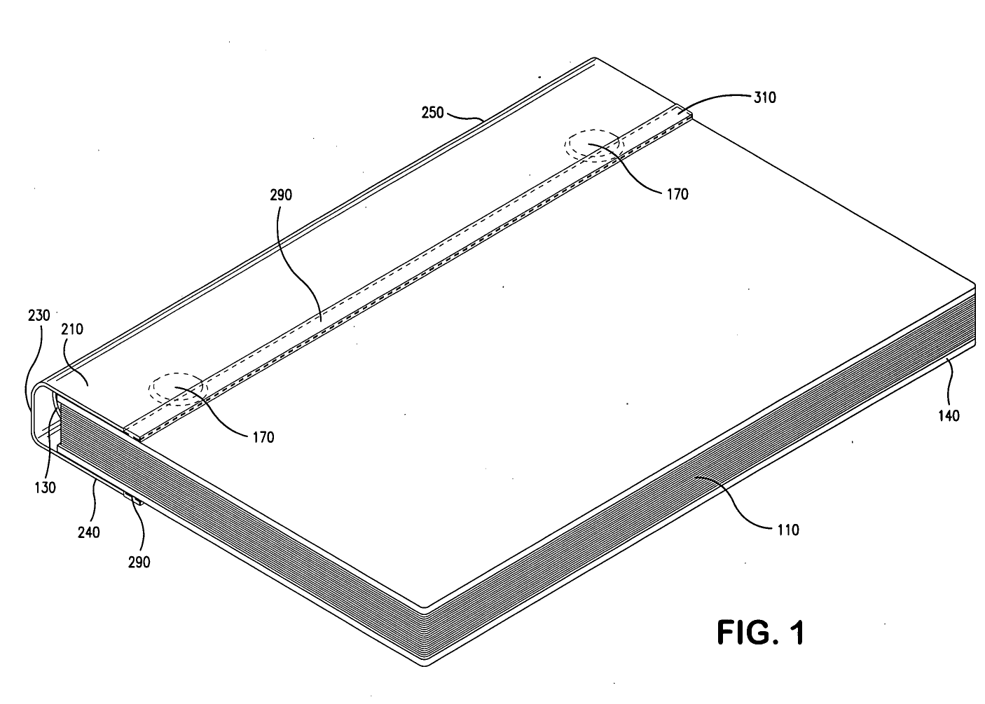

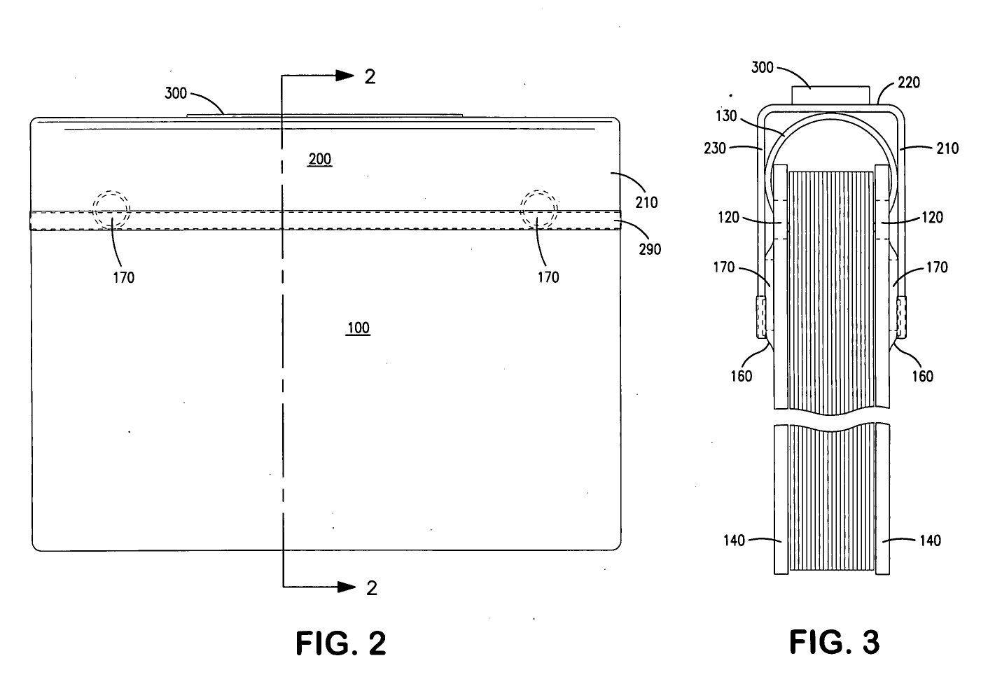

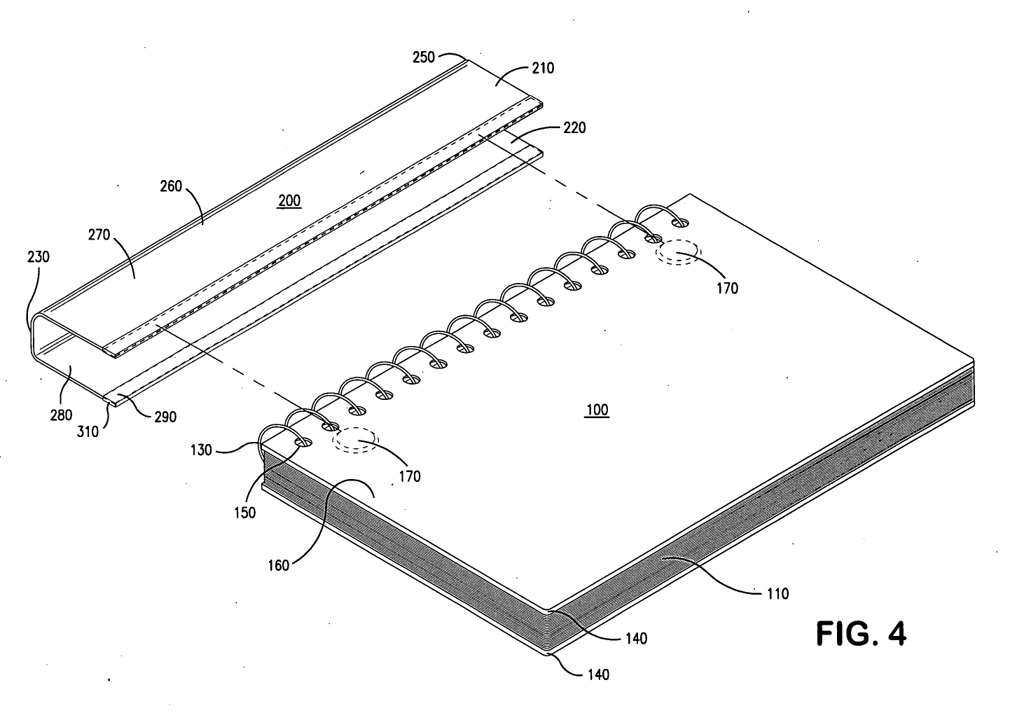

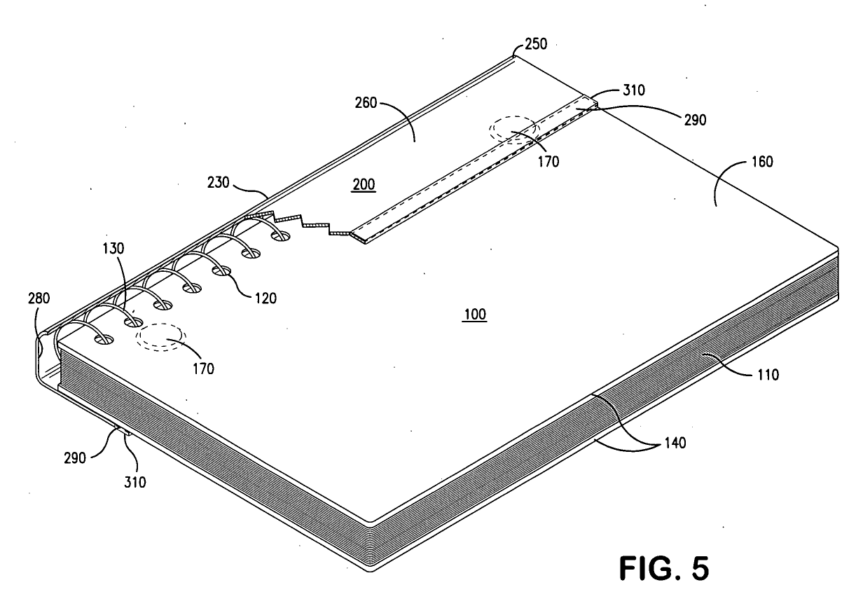

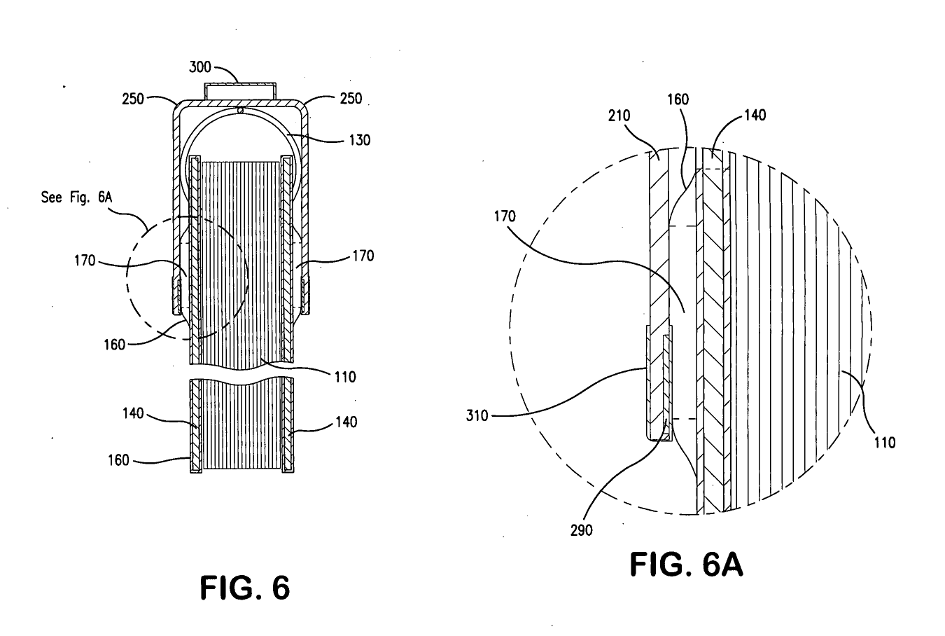

Referring now to the figures and particularly to FIGS. 1 through 6, in the broader aspects of the invention a blank book generally indicated at 100 includes a number of sheets or pages 110 having a series of holes defining openings 120 which are held together with a binding 130 which in the illustrated example is a metal spiral coil type binding. The blank book 100 further includes front and rear covers 140 that include holes defining openings 150 which correspond to the openings 120 in pages 110 that are similarly connected to the binding. The blank book is held together by the metal spiral wire or plastic spiral helix 130 that is threaded through the openings in the respective pages 110 and covers 140. Typically, the covers 140 are fabricated from rigid board, although the invention can be adapted to included thin flexible covers as well. The cover 140 is normally finished by covering it with a cover material 160 with a surface such as paper, vinyl, cloth, leather or any one of a variety of materials. The spiral 130 is commonly a magnetic material such as iron, but may be formed of plastic or other material. In accordance with the invention, the covers 140 include a magnetic material or magnet 170 which is embedded beneath or within the cover material. However, in an alternate construction, magnets may be exposed.

The magnets 170 are well known to those skilled in the art and in the prototypes that were constructed comprise disc shaped synthetic magnets as may be obtained from MMC, Corp. (Magnetic Materials and Components) of, Hauppauge, N.Y. 11788 USA. Alternatively, the magnets may be elongated high efficiency/strength magnets. In the prototypes, a pair of disc shaped magnets were positioned proximate the edge of the covers 140 proximate the spiral coil binding 130 approximately one inch from the respective top and bottom edges. For aesthetic purposes, the magnets 170 are preferably glued to the cover 140 beneath the decorative covering 160. Additionally, the magnets 170 should be sufficiently thin to be virtually imperceptible to the user. Alternatively, the magnets may be in powdered form and embedded within a suitable matrix such as glue [not shown] which is distributed longitudinally along the cover 140 edge proximate the binding. In another aspect of the invention, the cover 140 may include a cut out or hollowed out area to receive the magnet 170 to facilitate its imperceptibility to the user. In another aspect of the invention, the magnets may be visible and exposed.

The sleeve 200 comprises a front sleeve section 210, a back sleeve section 220 and a centrally positioned spine sleeve section 230. The spine sleeve section 230 is connected to the front sleeve section 210 on one side and is connected to the back sleeve section on the opposite side. Generally, the sleeve 200 will be constructed in the same manner as a hardbound book cover, with the same height as the bound/spine dimension but shorter on the non-bound dimension: that is to say the sleeve 200 is generally constructed of three separate pieces of board or other rigid material, the front 210, the back 220, and the spine 230, each of the three pieces spaced slightly away from each other and placed on a substrate 240 such as a single piece of paper, cloth or other material. The substrate 204 forms the connective tissue to the three sleeve sections 210, 220, 230 and connects them into one single piece (thereby creating the sleeve) with said spaces creating flexible hinges 250 on each side. Generally, the sleeve thus constructed will be covered with a cover material 260 which may or may not match the cover material used for the covering of the book itself. Alternatively, the sleeve 200 may be a single piece of other U-shaped material, such as an extruded or molded resin such as plastic (not shown), wherein the front sleeve section, back sleeve section and spine are all integrally formed as a single unit. The sleeve 200 has an outward facing side 270 which is visible to the user and an inward facing side 280 which will be facing the blank book 100 when in use. The sleeve 200 is provided with magnetizable strips or discs 290 positioned longitudinally on the inward facing side 280 along both the front sleeve section 210 and back sleeve section 220. In addition, magnetizable strips 290 may be longitudinally positioned on the inward facing side 280 of spine 230. However, depending on the construction of a particular blank book, it may be necessary to employ magnets of opposite polarity to those positioned on the blank book for additional attractive force. It is important to note that in a number of different types of blank books, notably the spiral coil blank book and the wire bound blank book, the respective spiral coil and wire bindings are often made of iron, a magnetic material which will attract the corresponding front and back sleeve sections 210,220 when in use, as will explained in further detail herein below.

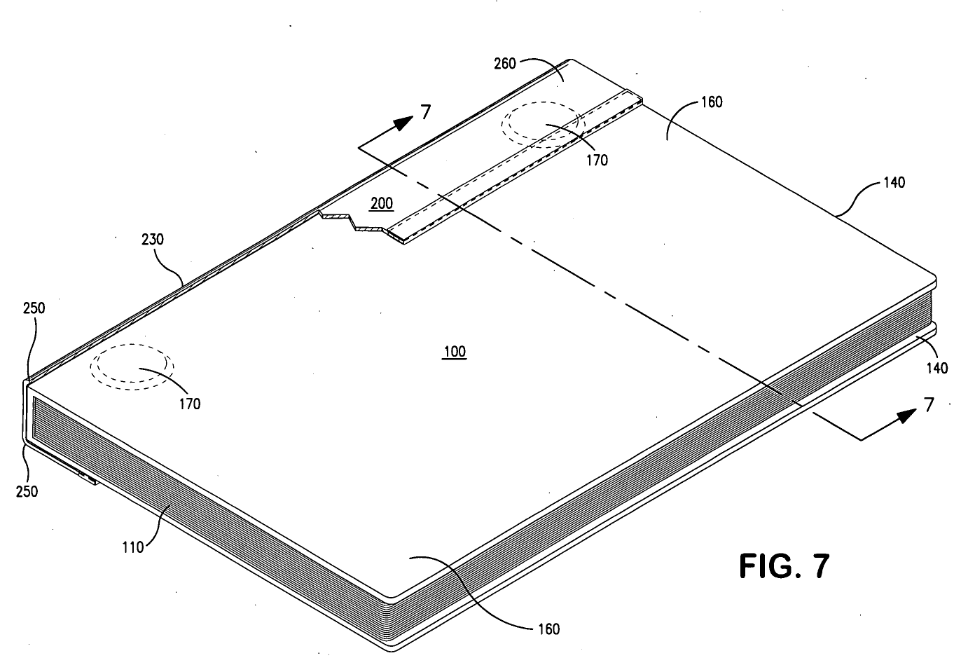

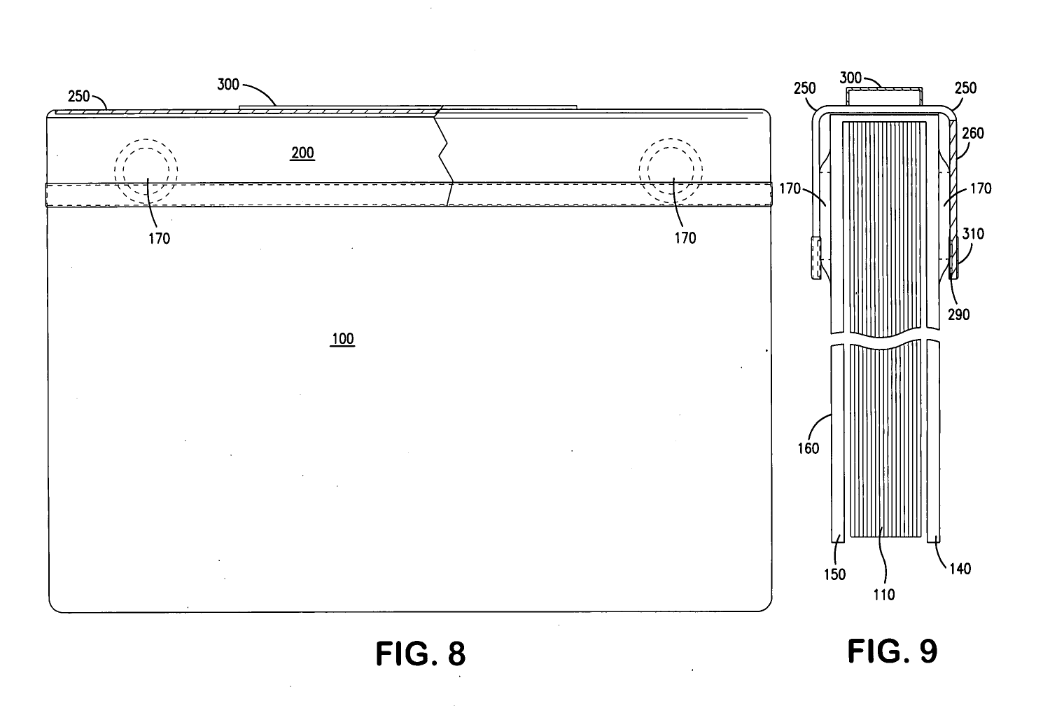

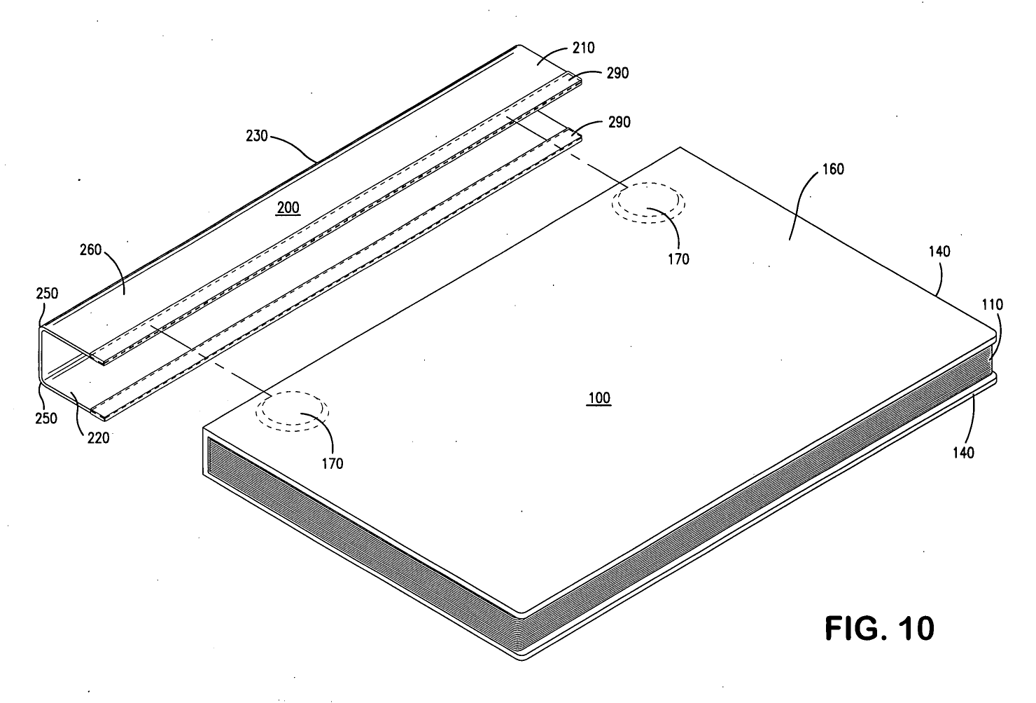

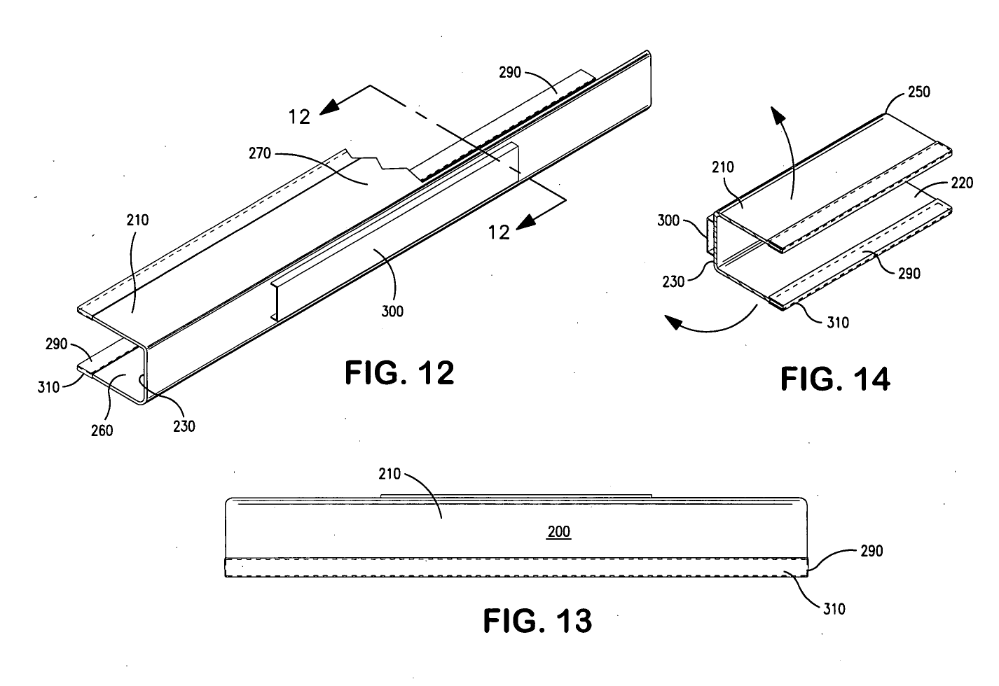

Another embodiment of the present invention is illustrated in FIGS. 7 through 14 wherein the blank book comprises a hardbound blank book 100 which differs from the spiral coil/wire bound blank book 100 previously described primarily in the manner of binding. The hardbound blank book 100 may be bound in any one of a number of techniques, well known to those in the bookbinding art. Fundamentally, the hardbound embodiment differs from the spiral coil binding embodiment by virtue of the hardbound book's tightly connected pages at the binding edge, an edge which forms a rigid and rectangular spine. More specifically, the hardbound blank book comprises a number of sheets of paper 110 that are bound together either by sewing, gluing or other method of adhesion, which when so connected form a “book block” 180; this “book block” is then attached to respective front and back covers 140 by gluing or other type of attachment, a process known to those in the bookbinding art as “casing in.” The “casing in” process may or may not include the use of endpapers, separate leaves of paper which are attached first to the book block and then to the cover 140, thus providing additional binding integrity by providing additional strength of the connection of the book block 180 to the front and back cover 140. The sleeve 200 that would be employed with the hardbound blank book is generally the same as that described above for the spiral coil sleeve, except that the position of the magnets is altered to match that of the hardbound book cover.

In operation, the sleeve 200 is wrappingly placed over the spine end of the blank book 100 so that the respective magnets 170, 290 of opposite polarity or; the magnets and magnetizable material, as the case may be, overlie one another so that the book 100 and the sleeve 200 are maintained in connected relation by magnetic forces of attraction. Further, in the illustrated embodiments, the sleeve 200 overlies between about twenty five (25) percent of the width of the respective front and back book covers 140, however, this figure may be increased or decreased as a particular application may require. It is believed that between fifteen percent (15%) and thirty five percent (35) of the width of the covers will be sufficient while remaining both aesthetic and functional. It will be noted that the sleeve 200 does not have to be the same height as the corresponding blank book 100 to which it is to be attached. Thus, by employing a sleeve 200 that is larger than the corresponding blank book 100, blank books of varying height, when placed adjacent to one another, can appear uniform when placed spine forward on a shelf.

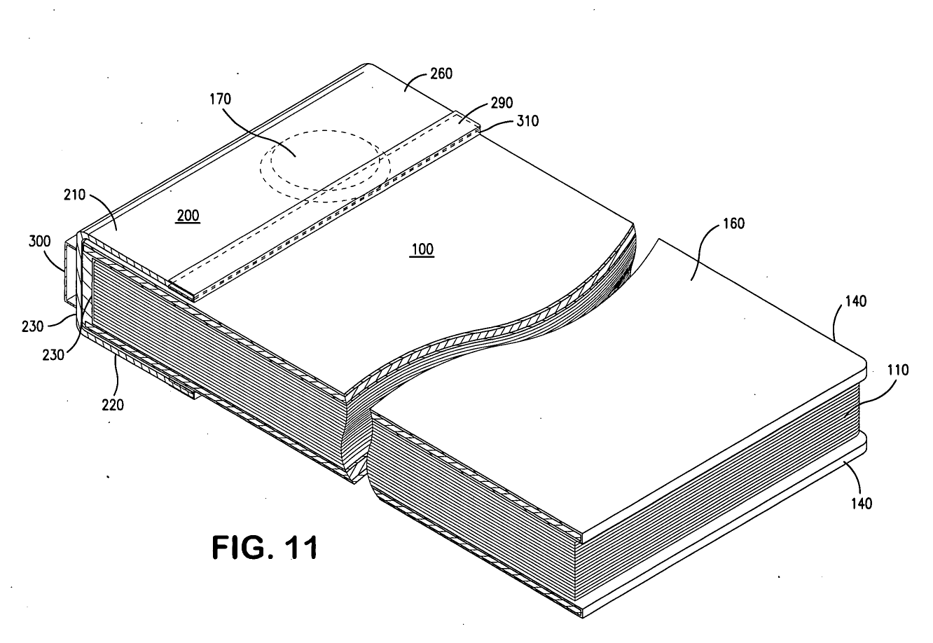

In another aspect of the invention, a labeling means or label holder 300 for identifying the contents of the corresponding blank book 100 is operatively associated or is attached to the spine 230 of sleeve 200, as best shown in FIGS. 3 and 11. The label holder 300 is fabricated from stamped metal as shown, plastic or any other material and is attached via conventional means such as nails, glue or other techniques of attachment, well known to those skilled in the art.

Another labeling technique for indicating the contents or type of notebook 100 is an indicator means for identifying the book such as a decorative stripe or strip 310, which extends along the length of the edge of the respective front and back sleeve sections 210,220. Alternatively, the sleeve may be partially or entirely color coded, or the strip 310 may extend horizontally across the sleeve or the stripe 310 may be positioned in the hinge area and extend on to portions of the front and back sleeve sections 210,220.

In another aspect of the invention, existing notebooks may be “retrofitted” with the sleeve 100 of the present invention. For example, magnetic strips or discs 170 could be attached to the covers 140,150 and/or spine of a notebook 100 as described herein above, except that they may be attached to the outer surface of the blank book 100. Additionally, the magnets 170 may be aesthetically enhanced with a decorative design.

The present invention may also be employed with a set of sleeves 200 as described herein above, and wherein each sleeve 200 of the set has a meaning denoted by a different color, different size, different indicator means 310 or combination of the foregoing, so that when the book and the sleeve are maintained in connected relation by magnetic forces of attraction, the book is coded as well as attractively archived.

In the drawings and specification that have been set forth herein, there are preferred embodiments of the invention and, although specific terms are employed, they are used in a generic and descriptive sense only and not for purposes of limitation, the scope of the invention being described in the claims.

That which is claimed is:

1. A sleeve adapted to be magnetically attached to a book of the type having a plurality of pages bound to a spine between a front cover and a back cover and wherein at least a portion of the book proximate the spine is magnetic or is magnetized, the sleeve comprising:
a front sleeve section and a back sleeve section and a centrally positioned spine sleeve section and wherein the spine sleeve section is connected to the front sleeve section on one side and is connected to the back sleeve section on the opposite side and further, wherein at least a portion of said sleeve is magnetized or is magnetic so that when said sleeve is positioned such that the front sleeve section, back sleeve section and spine sleeve section overlie the respective front cover, back cover and spine of the book, the book and the sleeve are maintained in connected relation by magnetic forces of attraction.

2. The sleeve according to claim 1 wherein said respective front sleeve section and said back sleeve section are hingedly connected to said spine.

3. The sleeve according to claim 1 wherein the respective front sleeve section and back sleeve section are adapted to cover less than the entire cover of the book.

4. The sleeve according to claim 1 wherein the magnet or magnetized material is positioned on top of the respective sleeve and book.

5. The sleeve according to claim 4 further including a board cover onto which has been mounted a cover material and wherein the magnetic or magnetized material is positioned beneath said cover material.

6. The sleeve according to claim 4 wherein magnetic or magnetized material is distributed within said cover.

7. The sleeve according to claim 4 wherein the magnetic or magnetized material is selected from the group consisting of powdered magnetic material, strip magnets and circular magnets.

8. The sleeve according to claim 2 wherein said front sleeve section and said back sleeve section include magnetic or magnetized material.

9. The sleeve according to claim 2 wherein said magnetic or magnetized material is distributed in the respective front and back sleeve sections along the longitudinal axis of said sleeve proximate said spine sleeve section.

10. The sleeve according to claim 1 further including a means for labeling the contents of the book.

11. The sleeve according to claim 1 further including an indicator means for indicating the contents of the book.

12. A sleeve adapted to be magnetically attached to a book of the type having a plurality of pages bound to a spine between a front cover and a back cover and wherein at least a portion of the book proximate the spine is magnetic or magnetized, the sleeve comprising:
a front sleeve section and a back sleeve section and a centrally positioned spine sleeve section and wherein the spine sleeve section is hingedly connected to the front sleeve section on one side and is hingedly connected to the back sleeve section on the opposite side and wherein the respective front and back sleeve sections are smaller than the corresponding front and back book covers and further, wherein at least a portion of said sleeve includes a magnet or magnetic material such that when said sleeve is positioned such that the front sleeve section, back sleeve section and spine sleeve section overlie the respective front cover, back cover and spine of the book, the book and sleeve are maintained in connected relation by magnetic forces of attraction between the corresponding sections of the book and the sleeve.

13. The sleeve according to claim 12 wherein the magnetic or magnetized material is positioned within said sleeve in a manner which so as not to be exteriorly visible.

14. The sleeve according to claim 12 wherein the magnetic or magnetized material is selected from the group consisting of metal particles, magnetic particles and magnetized particles.

15. The sleeve according to claim 12 wherein the magnetic or magnetized material is distributed within the respective front sleeve section and back sleeve section and further, wherein said sleeve further includes a cover material, and wherein the magnetic or magnetized material is positioned beneath said cover material.

16. The sleeve according to claim 12 wherein the magnet or magnetized material is positioned on top of the respective sleeve and book.

17. A system for archiving books of varying types and sizes for ease of identification and retrieval comprising, in combination:
a) a book of the type having a plurality of pages bound to a spine between front and back covers and wherein at least a portion of the book proximate the spine is magnetized or is magnetic; and
b) a sleeve comprising a front sleeve section and a back sleeve section and a centrally positioned spine sleeve section and wherein the spine sleeve section is connected to the front sleeve section on one side and is connected to the back sleeve section on the opposite side and further, wherein at least a portion of said sleeve is magnetized or magnetic such that when said sleeve is positioned so that the front sleeve section, back sleeve section and spine sleeve section overlie the respective front cover, back cover and spine of the book, the book and the sleeve are maintained in connected relation by magnetic forces of attraction.

18. The system according to claim 17 wherein the magnetic or magnetized material is operatively associated with the respective front cover, back cover or spine of the book so as to be substantially invisible.

19. The system according to claim 17 wherein the magnetic or magnetized material is positioned beneath a cover material mounted onto the sleeve.

20. The sleeve according to claim 17 wherein the magnet or magnetized material is positioned on top of the respective sleeve and book.

21. The system according to claim 18 wherein the magnetic or magnetized material is embedded within the cover material of the respective sleeve and book.

22. The system according to claim 18 wherein the respective front and back sleeve sections are adapted to overlie between about fifteen percent and thirty five percent of the width of the respective front and back book covers.

23. The system according to claim 18 wherein said magnetic or magnetized material is distributed along the longitudinal axis of said sleeve proximate said spine sleeve section.

24. The system according to claim 17 further including a means for labeling the contents of the book, said labeling means being operatively associated with said spine.

25. The system according to claim 17 further including an indicator means for indicating the contents of the book.

26. A system for organizing and archiving books of varying types and sizes for ease of identification and retrieval comprising in combination:
a) a book of the type having a plurality of pages bound to a spine between front and back covers and wherein at least a portion of the book proximate the spine is magnetized or is magnetic; and
b) a set of sleeves, said sleeves of said set comprising a front sleeve section and a back sleeve section and a centrally positioned spine sleeve section and wherein the spine sleeve section is hingedly connected to the front sleeve section on one side and is hingedly connected to the back sleeve section on the opposite side and further, wherein at least a portion of said sleeve is magnetized such that when said sleeve is positioned such that the front sleeve section, back sleeve section and spine sleeve section overlie the respective front cover, back cover and spine of the book, and wherein each sleeve of said set has a meaning denoted by a different color, different size, different indicator means or combination of the foregoing, so that when the book and the sleeve are maintained in connected relation by magnetic forces of attraction, the book is attractively archived.

27. The system according to claim 26 wherein the magnetic or magnetized material is operatively associated with the respective front cover, back cover or spine of the book so as to be substantially invisible.

28. The system according to claim 26 wherein the magnetic or magnetized material is positioned beneath a cover material mounted onto said sleeve.

29. The system according to claim 26 wherein the magnetic or magnetized material is embedded within the cover material of the respective sleeve and book.

30. The sleeve according to claim 26 wherein the magnet or magnetized material is positioned on top of the respective sleeve and book.

31. The system according to claim 26 wherein the respective front and back sleeve sections are adapted to overlie between about fifteen percent and thirty five percent of the width of the respective front and back book covers.

32. The system according to claim 26 wherein said magnetic or magnetized material is distributed along the longitudinal axis of said sleeve proximate said spine sleeve section.

33. The system according to claim 26 further including a means for labeling the contents of the book, said labeling means being operatively associated with said spine.

34. The system according to claim 26 further including an indicator means for indicating the contents of the book.
